(19) United States
(12) Patent Application Publication
(10) Pub. No.: US 2008/0087446 A1
(43) Pub. Date: Apr. 17, 2008

(54) SELF-ACTIVATED FIRE EXTINGUISHER

(75) Inventor: Abdul Sitabkhan, Arcadia, CA (US)

Correspondence Address: KELLY LOWRY & KELLEY, LLP, 6320 CANOGA AVENUE, SUITE 1650, WOODLAND HILLS, CA, 91367, US

(73) Assignee: AMERON GLOBAL, INC., Valencia, CA (US)

(21) Appl. No.: 11/550,064

(22) Filed: Oct. 17, 2006

(51) Int. Cl. A62C 37/12; A62C 37/50

(52) U.S. Cl. 169/57; 169/74; 169/77; 169/89

(57) ABSTRACT

An automatic fire extinguisher that is self-activated in the presence of specified temperature. The fire extinguisher includes a sealed pressure vessel having a fitting and a tube permitting access to the contents of the pressure vessel. A valve in the end of the tube includes a fusible alloy temperature sensor designed to melt or soften in the presence of heat and/or flame. Once the temperature sensor softens or melts, the contents of the pressure vessel are released through the valve thereby extinguishing the fire. A capillary tube is provided to charge the pressure vessel with fire suppressant agent and a pressurized gas.

### BACKGROUND OF THE INVENTION

This invention relates generally to fire extinguishers, particularly of the type that are self-activated, i.e., as in the case of a heat sensor or a fire sensor. In addition, the fire extinguisher of the present invention is designed particularly for use as a Christmas tree ornament or other decoration. The fire extinguisher is heat activated and requires no electrical or battery power to function.

Fire extinguishers that automatically discharge in the presence of heat and/or fire are well known in the art. U.S. Pat. No. 3,171,493 to Barr discloses a fire protection device for a Christmas tree, wherein a valve opening is obstructed by one end of a pair of aligned rods held together by fusible metal which melts upon a corresponding rise in temperature. The valve opening is configured to eject a fire extinguishing foam upward so that it reflects off of a concave surface.

U.S. Pat. No. 2,876,845 to Boyce discloses a fire extinguisher for Christmas trees that operates automatically. The fire extinguisher includes a valve obstructed by a spring loaded gasket member held in place by a cup structure secured by a metal bead. The metal bead is constructed from a material designed to melt at a desired temperature. When the metal bead melts, the spring loaded gasket and cup structure are ejected thereby permitting the fire suppression agent to be ejected from the fire extinguisher.

U.S. Pat. No. 2,786,537 to Wainess is directed to a self-energizing fire extinguisher that has an elongate cylindrical valve member or stem which is retracted within the fire extinguisher and held in place by a low temperature melting solder. In the presence of heat the solder melts and the cylindrical valve member or stem is permitted to extend from the fire extinguisher thereby releasing the fire suppressant material.

U.S. Pat. No. 2,871,952 to Doak discloses a fire extinguisher having a closed valve member. An impact element or hammer having an elongated slot is positioned around the end of the valve member and held in place by a fusible link designed to rupture in the presence of heat. The impact element or hammer is spring loaded such that when the fusible link ruptures the spring draws the impact element or hammer against the valve member thereby breaking the stem of the valve member and releasing the fire suppressant material.

In each of these prior art devices the fire suppressant is aimed in the general direction in which the valve of the fire extinguisher itself is pointed and such fire extinguishers generally tend to have one valve. Some of the prior art devices provide reflective and/or deflective shields to increase the coverage area of the fire suppressant material. Another prior art device includes an oscillating valve member that slightly varies the direction of spray of the fire suppressant material. None of the prior art devices provide for easily recharging the fire extinguisher with new fire suppressant material after use. Such prior art devices typically need to be reconstructed in order to recharge the same.

Accordingly, it is an object of this invention to provide a fire extinguisher having one or more valve members that are easily configurable to point in one or more directions. In addition, it is an object of this invention to provide a fire extinguisher that is easily recharged and reset. The present invention fulfills all these needs and provides other related advantages.

### SUMMARY OF THE INVENTION

The present invention resides in a self-activating fire extinguisher comprising a pressure vessel having an outlet passageway, a fire suppressant agent and a pressurized gas inside the pressure vessel, and a valve disposed within the outlet passageway having a temperature sensor for opening the valve in case of a fire. A fitting having a metallic or polymer seal is disposed between the pressure vessel and the valve. A tube in which the valve is disposed may extend from the fitting. The tube may include a capillary inlet for recharging the fire extinguisher. The valve may also include a conical plug for distributing the fire suppressant agent over a wider area.

The fire extinguisher may comprise two or more tubes extending from a single fitting. Each tube would contain its own valve having its own temperature sensor. The tubes may be configured with different lengths and/or diameters. The temperature sensors in each of the valves of the multiple tubes may be activated at different temperatures.

The fire suppressant agent preferably comprises a liquid, a powder, or a combination of liquid and powder. The pressurizing gas preferably comprises an inner gas such as nitrogen. The pressure vessel may comprise any of multiple shapes but is preferably spherical or cylindrical and possesses external decoration to resemble a Christmas tree ornament.

Other features and advantages of the present invention will become apparent from the following more detailed description, taken in conjunction with the accompanying drawings which, by way of example, illustrate the principles of the invention.

### BRIEF DESCRIPTION OF THE DRAWINGS

The accompanying drawings illustrate the invention. In such drawings:

FIG. 1 is an environmental view of the fire extinguisher of the present invention hung on a Christmas tree;

FIG. 2 is an elevated perspective view of a fire extinguisher of the present invention;

FIG. 3 is an exploded view of a tube and fitting for use in a fire extinguisher of the present invention; and

FIG. 4 is a cross-sectional view of the tube and fitting of the present invention taken along line 4-4 of FIG. 2.

### DETAILED DESCRIPTION OF THE PREFERRED EMBODIMENTS

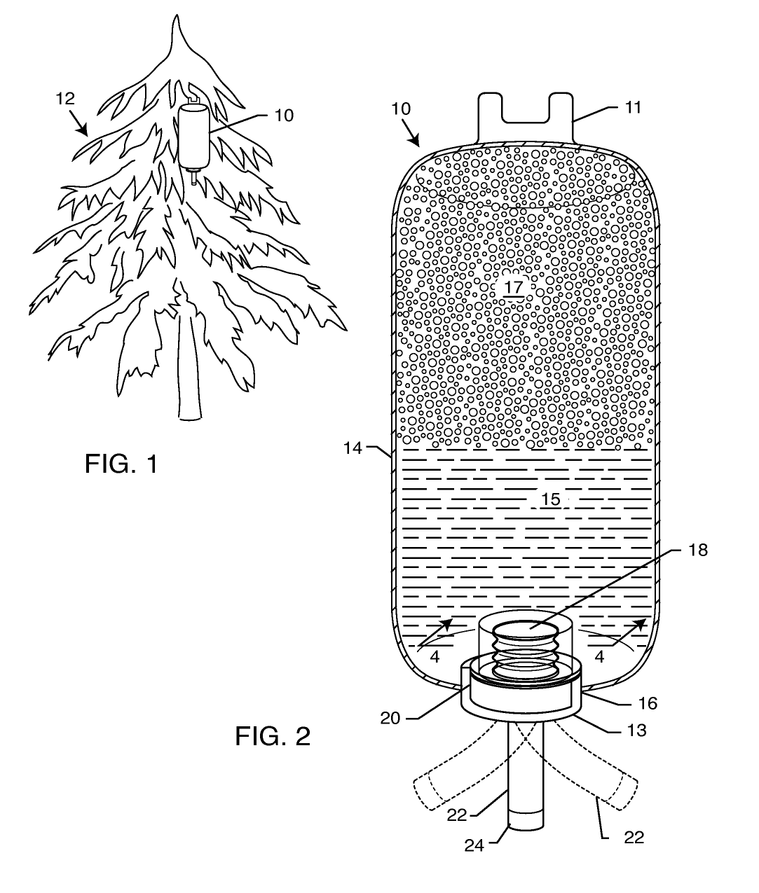

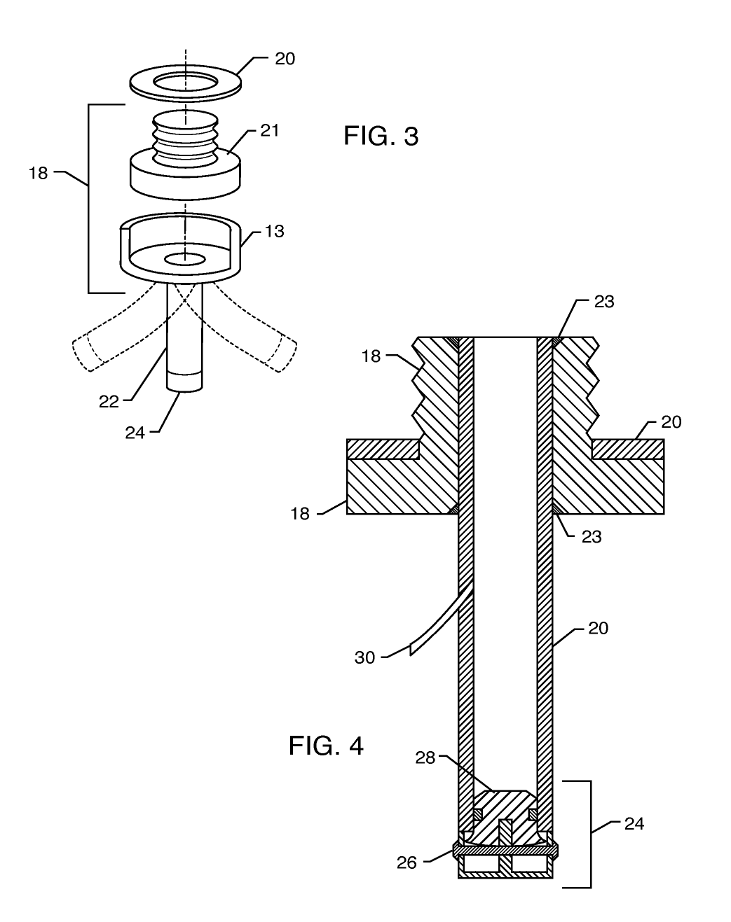

As shown in the drawings for purposes of illustration, the present invention relates to a self-activated fire extinguisher primarily for use as a Christmas tree ornament or decoration. FIG. 1 depicts the self-activated fire extinguisher 10 in an environmental view on a Christmas tree 12. FIGS. 2-4 illustrate a preferred embodiment of the self-activating fire extinguisher 10.

The self-activating fire extinguisher 10 consists of a plastic pressure vessel 14 that can be molded or configured in a variety of shapes such as spherical or cylindrical. The pressure vessel 14 may or may not be painted or decorated with an external facade to suit various usage requirements, i.e., as a Christmas decoration. The pressure vessel 14 includes mounting tabs 11 integrally molded onto the surface.

The pressure vessel 14 is capable of housing a variety of fire suppressant agents such as a liquid, a powder, or combinations of both. Such fire suppressant agents include Purple K Powder or any bicarbonate compound in a water solution. The fire suppressant agent may also include Envirogel or any halocarbon compound. The pressure vessel 14 also contains a pressurized gas to ensure that the fire suppressant agents are under sufficient pressure to be ejected from the fire extinguisher 10 when it is activated. The pressurized gas preferably comprises nitrogen at a pressure of 20-30 psig. Other inert gases may be used at similar pressures. The primary purpose of the pressurized gas is to eject the fire suppressant agents in a timely manner.

The pressure vessel 14 includes an outlet passageway 16. A metal boss 13 is embedded into the pressure vessel 14 around the outlet passageway 16. A plug or fitting 18 is positioned within the outlet passageway 16 and seals the pressure vessel 14 with a metallic or polymer seal 20. The seal 20 may comprise a tin plated soft copper washer, O-ring or other similar device mounted against a sealing surface 21 on the fitting 18.

One or more tubes 22 may be mounted on the fitting 18 to provide access to the pressure vessel 14 through the outlet passageway 16. The tubes 22 are brazed 23 to the fitting both internally and externally. The tubes 22 may be of different lengths and/or diameters to provide for different patterns of fire suppressant agent to be discharged from the fire extinguisher 10.

The ends of the tubes 22 farthest from the pressure vessel 14 include a valve mechanism 24 and a temperature sensor 26. The valve mechanism 24 allows for the contents of the pressure vessel 14 to be discharged into the designated fire zone. The valve 24 is spot welded, brazed or threaded onto the end of the tubes 22. The temperature sensor 26 comprises a fusible alloy that maintains the valve in a closed position for a normally charged fire extinguisher 10. The temperature sensor 26 is a specially formulated metal alloy that softens and melts at a precise temperature or temperature range. Preferably that temperature or temperature range approximates the temperature which the intended fire to be extinguished would likely burn. In the preferred embodiment this temperature range is between 225° F. and 235° F. Upon exposure to heat and/or flame the temperature sensor 26 will soften and/or melt, thereby allowing the pressure inside the pressure vessel 14 to open the valve. The pressure in the fire extinguisher 10 will force the fire suppressant agent to discharge into the fire zone, i.e., the direction in which the tubes 22 are pointing. A conical plug 28 may be positioned within the valve to allow the fire suppressant agent to discharge in a uniform 360° pattern. Where multiple tubes 22 are used, each tube may include a temperature sensor 26 with a melting point different from temperature sensors 26 in other tubes 22. Further, each tube 22 may include a conical plug 28 with a slightly different shape from the conical plugs 28 used in other tubes 22 to create differing discharge patterns.

One or more of the tubes 22 may include a capillary tube 30 for charging the pressure vessel 14 with fire suppressant agent and/or pressurized gas. The capillary tube 30 is preferably brazed to the tube to create a seal. Once the pressure vessel 14 is charged, the capillary tube 30 subsequently hermetically seals the fire extinguisher 10.

Although several different embodiments of the present invention have been illustrated and described in detail, various modifications may be made without departing from the spirit and scope of the invention. Accordingly, the invention is not to be limited, except as by the appended claims.

What is claimed is:

1. A self-activating fire extinguisher, comprising:
a pressure vessel having an outlet passageway;
a fire suppressant agent and a pressurized gas inside the pressure vessel; and
a valve disposed within the outlet passageway having a temperature sensor for opening the valve in case of a fire.

2. The self-activating fire extinguisher of claim 1, further comprising a fitting having a metallic or polymer seal, said fitting being disposed between the pressure vessel and the valve.

3. The self-activating fire extinguisher of claim 2, further comprising a tube extending from said fitting in which said valve is disposed.

4. The self-activating fire extinguisher of claim 3, further comprising two or more tubes extending from said fitting, each tube containing a respective valve having a temperature sensor, said tubes having different lengths or different diameters.

5. The self-activating fire extinguisher of claim 4, wherein the temperature sensors are activated at different temperatures.

6. The self-activating fire extinguisher of claim 3, wherein the tube includes a capillary inlet.

7. The self-activating fire extinguisher of claim 1, including a conical plug associated with the valve for distributing the fire suppressant agent over a wide area.

8. The self-activating fire extinguisher of claim 1, wherein the fire suppressant agent comprises a liquid, a powder, or a combination of liquid and powder.

9. The self-activating fire extinguisher of claim 1, wherein the pressurizing gas comprises nitrogen or another inert gas.

10. The self-activating fire extinguisher of claim 1, wherein the pressure vessel is spherical or cylindrical in shape and has external decoration to resemble a Christmas tree ornament.

11. A self-activating fire extinguisher, comprising:
a pressure vessel having an outlet passageway;
a fire suppressant agent and a pressurized gas inside the pressure vessel;
a valve disposed within the outlet passageway having a temperature sensor for opening the valve in case of a fire;
a fitting having a metallic or polymer seal, said fitting being disposed between the pressure vessel and the valve;
the fire suppressant agent comprises a liquid, a powder, or a combination of liquid and powder; and
the pressurizing gas comprises nitrogen or another inert gas.

12. The self-activating fire extinguisher of claim 11, further comprising a tube extending from said fitting in which said valve is disposed.

13. The self-activating fire extinguisher of claim 12, further comprising two or more tubes extending from said fitting, each tube containing a respective valve having a temperature sensor, said tubes having different lengths or different diameters.

14. The self-activating fire extinguisher of claim 13, wherein the temperature sensors are activated at different temperatures.

15. The self-activating fire extinguisher of claim 12, wherein the tube includes a capillary inlet.

16. The self-activating fire extinguisher of claim 11, including a conical plug associated with the valve for distributing the fire suppressant agent over a wide area.

17. The self-activating fire extinguisher of claim 11, wherein the pressure vessel is spherical or cylindrical in shape and has external decoration to resemble a Christmas tree ornament.

18. A self-activating fire extinguisher, comprising:
a pressure vessel having an outlet passageway;
a fire suppressant agent and a pressurized gas inside the pressure vessel;
a valve disposed within the outlet passageway having a temperature sensor for opening the valve in case of a fire;
a fitting having a metallic or polymer seal, said fitting being disposed between the pressure vessel and the valve;
a tube extending from said fitting in which said valve is disposed; and
a conical plug associated with the valve for distributing the fire suppressant agent over a wide area.

19. The self-activating fire extinguisher of claim 18, further comprising two or more tubes extending from said fitting, each tube containing a respective valve having a temperature sensor, said tubes having different lengths or different diameters, wherein the temperature sensors are activated at different temperatures.

20. The self-activating fire extinguisher of claim 18, wherein the tube includes a capillary inlet.

21. The self-activating fire extinguisher of claim 18, wherein the fire suppressant agent comprises a liquid, a powder, or a combination of liquid and powder, wherein the pressurizing gas comprises nitrogen or another inert gas.
